(19) United States
(12) Patent Application Publication
(10) Pub. No.: US 2002/0151332 A1
(43) Pub. Date: Oct. 17, 2002

(54) Apparatus and methods for improved tower mountable systems for cellular communications

(75) Inventor: Michael M. Eddy, Santa Barbara, CA (US)

Correspondence Address: LYON & LYON LLP, 633 WEST FIFTH STREET, SUITE 4700, LOS ANGELES, CA, 90071, US

(73) Assignee: Superconductor Technologies, Inc.

(21) Appl. No.: 10/102,611

(22) Filed: Mar. 19, 2002

Related U.S. Application Data
(60) Provisional application No. 60/277,418, filed on Mar. 19, 2001.
(60) Provisional application No. 60/277,419, filed on Mar. 19, 2001.

(51) Int. Cl. H04B 1/38

(52) U.S. Cl. 455/561; 455/562

(57) ABSTRACT

Methods and apparatus are provided for a cellular communication system including superconducting components. More particularly, the inventions of this system include a tower mounted transmitter/receiver system having one or more antenna disposed atop a tower. The system includes a receive side subsystem having at least one superconducting component, such as an HTS filter. The system further includes a transmit side subsystem having an amplifier, preferably a power amplifier. The receive side subsystem and the transmit side subsystem are both disposed atop the tower substantially adjacent the antenna. Duplexed and multiplexed systems may be utilized. One or more connections may be provided between the tower mounted transmitter/receiver system and the ground or base station.

### CROSS-REFERENCE TO RELATED APPLICATIONS

The present application claims priority under 35 U.S.C. §119(e) from co-pending U.S. Provisional Application Serial No. 60/277,418, entitled “Apparatus and methods for improved tower mount systems for cellular communications,” filed Mar. 19, 2001, and from co-pending U.S. Provisional Application Serial No. 60/277,419, entitled “Method and apparatus for combined receive and transmit subsystems in cellular communication systems,” filed Mar. 19, 2001, the disclosures of which are expressly incorporated herein by reference in their entireties.

### FIELD OF THE INVENTION

This invention relates generally to the field of telecommunications and cellular communications, such as, e.g., cellular telephone communications. More particularly, this invention relates to telecommunications and cellular communications systems that may include the use of tower mountable superconducting components, such as superconducting filter receiver systems, power amplified transmitter systems, and related enclosures.

### BACKGROUND

Radio frequency (RF) equipment have used a variety of approaches and structures for receiving and transmitting radio waves and other signals in selected frequency bands. The type of filtering structure used often depends upon the intended use and the specifications for the radio equipment. For example, dielectric filters may be used for filtering electromagnetic energy in the ultra-high frequency (UHF) band, such as, e.g., those used for cellular communications in the 800+ MHz frequency range. Because of an increase in the number of users utilizing a limited bandwidth, demand has increased for greater frequency selectivity than can be provided by normal or non-superconducting resonator filters, especially for RF signals in the ultra-high frequency bands that may be used for cellular communications. As a result, substantial attention has recently been devoted to the development of high temperature superconducting (HTS) RF filters for use in, for example, cellular telecommunications systems, to accomplish and optimize high frequency selectivity.

HTS RF filters, or HTS front-end filters, may, however, be susceptible to failure or degradation in performance. For example, HTS front-end filters may fail when exposed to lightning surges or other high power signals. Furthermore, such filters are extremely temperature sensitive. For example, the use of such filters within tower mounted communications systems can raise significant heat management issues. One such issue is temperature regulation of a cold finger in a cryocooler used with an HTS filter system. U.S. Pat. No. 6,098,409, entitled “Temperature control of high temperature superconducting thin film filter subsystems,” and U.S. Pat. No. 6,256,999, also entitled “Temperature control of high temperature superconducting thin film filter subsystems,” address the issue of temperature regulation of a cold finger in a cryocooler. The disclosures of the '409 and the '999 patents are expressly and fully incorporated by reference herein. Another equally important issue is heat dissipation. Stated somewhat differently, for an HTS filter system to function properly, the heat of compression generated by a cryocooler incorporated within the system must be efficiently and reliably rejected to the ambient environment. If that heat generated by the cryocooler cannot be efficiently and reliably rejected, it may have a serious impact upon system operation. Depending upon the circumstances, insufficient heat dissipation into the ambient environment could result in inefficient cryocooler operation and/or cryocooler shut down. U.S. Pat. No. 6,311,498, entitled “Tower mountable cryocooler and HTSC filter system,” addresses one method of dealing with heat dissipation in HTS filter systems. The disclosure of the '498 is expressly and fully incorporated herein by reference.

Current tower mounted communications systems may include a receive side subsystem, such as an HTS filter system, mounted on the mast or tower. The transmit side subsystem, such as a power amplified transmitter, in comparison, is typically housed in a base station at the bottom of the tower. Those of ordinary skill in the art have been reluctant to mount transmit side subsystems at an elevated point on the tower. This reluctance on the part of those of ordinary skill in the art may be partly attributed to liability concerns regarding injuries to passersby that may be inflicted as a result of falling transmit side subsystems. In current tower mounted systems, a cable must be extended, or run, from a transmit side subsystem, typically located within the base station, to the antenna or antennas at an elevated point on the tower. The length of cable required, which will vary depending on the height of the tower, the elevation of the antennas, and the distance of the base station from the antenna, inevitably results in some signal loss. Accordingly, current transmit side subsystems must generate an adequate amount of power from the power amplified transmitter to overcome any signal loss due to the cable that must be run between the transmit side subsystem and the elevated antenna. These power amplified transmit side subsystems must therefore be able to generate a large amount of power, and, as a result, consume a large amount of energy. In addition to requiring a great deal of energy to operate, the placement of these power amplified transmit side subsystems in the base station generates a significant amount of heat within the base station itself, thereby requiring enhanced environmental cooling systems within the base station. The use of these enhanced cooling systems within the base station also increases the amount of energy required to operate the tower mounted telecommunications system.

Thus, those of ordinary skill in the art would find an improved tower mounted communications system that reduces the cable run between the transmit side subsystem and the elevated antenna or antennas to be quite useful. It is also believed that those skilled in the art would find a tower mounted communications that may be operable with a less powerful amplified transmitter, compared to those currently used in known tower mounted systems, to be useful. Those skilled in the art would also find a communications system with remote units near the users to be useful.

### SUMMARY OF THE INVENTION

The present invention is directed to methods and systems for transmitting and receiving telecommunications signals. More particularly, the present invention is directed to tower mountable transmitter/receiver systems that incorporate superconducting materials. The systems of the present invention are optimized for transmitting and receiving telecommunications signals.

In one aspect of the present invention, a tower mounted transmitter/receiver system is provided. The system may include a transmit antenna and a receive antenna disposed on a tower. The system may also have a transmit side subsystem with a powered amplifier that is disposed atop the tower and in communication with the transmit antenna. Additionally, a receive side subsystem disposed atop the tower and in communication with the receive antenna may be incorporated into the system. The receive side subsystem preferably incorporates an HTS filter. Also, the system may include a transmission path extending between a base station located at a base of the tower and the transmit and receive side subsystems.

The transmit and receive antennas of this system may be incorporated into a single combined transmit/receive antenna. In this embodiment, the system further comprises a first duplexer coupled to the combined antenna, the transmit side subsystem, and the receive side subsystem. This first duplexer is preferably configured to provide a transmit signal to the combined antenna from the transmit side subsystem, and to provide a receive signal to the receive side subsystem from the combined antenna. The system may also incorporate a second duplexer coupled to the transmit side subsystem, the receive side subsystem, and the transmission path. Here, the second duplexer is preferably configured to provide a transmit signal to the transmit side subsystem, and to send a receive signal to the base station via the transmission path. Additionally, the system may include receive electronics disposed within the base station, transmit electronics disposed within the base station, and a third duplexer coupled to the transmission path, the receive electronics and the transmit electronics. The third duplexer may be configured to provide a receive signal to the receive electronics relayed from the second duplexer via the transmission path, and to send a transmit signal from the transmit electronics to the second duplexer via the transmission path.

The system may include a power distribution unit. The power distribution unit may be coupled to the receive electronics and the transmit electronics. The power distribution unit is preferably configured to balance a strength of a transmit signal generated by the transmit electronics with a strength of a receive signal received by the receive electronics. In one embodiment, the receive electronics, the transmit electronics, and the power distribution unit all may be disposed within the base station.

The transmit side subsystem of the system may include a RF filter that is in communication with the power amplifier and the transmit antenna. Additionally, the receive side subsystem may include a cryocooler, a cryogenic enclosure in thermal communication with the cryocooler, and a low noise amplifier coupled to the HTS filter. The HTS filter and the low noise amplifier may be disposed within the cryogenic enclosure.

In another embodiment, the transmit side subsystem may include a signal combiner, a plurality of power amplifiers coupled to the signal combiner, and a RF transmitter filter coupled to the signal combiner. The signal combiner preferably receives a plurality of transmitted signals from the plurality of power amplifiers, combines the plurality of transmitted signals into a single transmitted signal, and relays the transmitted signal to the RF transmitter filter.

In another aspect of the present invention, another tower mounted transmitter/receiver system is provided. The system may includes an antenna that is disposed atop a tower. The antenna is preferably configured to both receive and transmit RF signals. A transmit side subsystem disposed atop the tower may also be included in the system. The transmit side subsystem may be in communication with the antenna, and may include a powered amplifier. The system may also incorporate a receive side subsystem disposed atop the tower and in communication with the antenna. This receive side subsystem may include an HTS filter. Receive electronics in communication with the receive side subsystem may be provided. Similarly, transmit electronics that are in communication with the transmit side subsystem may also be provided with this system.

In one embodiment of this system, the receive side subsystem further includes a cryocooler, a cryogenic enclosure in thermal communication with the cryocooler, a cold stage within the cryogenic enclosure, and a low noise amplifier coupled to the HTS filter. Preferably, the HTS filter and the low noise amplifier are located within the cryogenic enclosure, and are disposed upon the cold stage. Also, the transmit side subsystem may further comprise a RF transmitter filter coupled to the power amplifier. The RF transmitter filter is preferably configured to relay transmitted signals from the power amplifier to the antenna.

The system may further include a plurality of duplexers. For example, the system may include a first duplexer coupled to the receive electronics and the transmit electronics, a second duplexer coupled to the transmit side subsystem, the receive side subsystem, and the first duplexer, and a third duplexer coupled to the antenna, the transmit side subsystem, and the receive side subsystem. In this embodiment, the first duplexer is preferably configured to relay received signals from the second duplexer to the receive electronics and relay transmitted signals from the transmit electronics to the second duplexer. Additionally, the second duplexer is preferably configured to relay transmitted signals from the first duplexer to the transmit side subsystem and relay received signals from the receive side subsystem to the first duplexer. Also, the third duplexer is preferably configured to receive transmitted signals from the transmit side subsystem, relay the transmitted signals to the antenna, receive received signals from the antenna, and relay the received signals to the receive side subsystem. Furthermore, the first duplexer, the receive electronics, and the transmit electronics may all be disposed within a base station.

In another aspect of the present invention, another tower mounted transmitter/receiver system is provided. The system may include an antenna configured to receive and transmit RF signals. A transmit side subsystem disposed atop the tower may be provided. The transmit side subsystem may be in communication with the antenna. The transmit side subsystem may also be configured to process digital signals. Additionally, a receive side subsystem disposed atop the tower may be provided. The receive side subsystem may be in communication with the antenna. As with the transmit side subsystem, the receive side subsystem may be configured to process digital signals. The system may also include a digital transmission path between a base station located at a base of the tower and the transmit and receive side subsystems. The antenna may comprise a transmit antenna in communication with the transmit side subsystem, as well as a receive antenna in communication with the receive side subsystem. Additionally, the digital transmission path may comprise a fiber optic cable.

In one embodiment of this system of the present invention, the transmit side subsystem preferably includes a digital to analog converter coupled to the digital transmission path, an up-conversion unit coupled to the digital to analog converter, and a power amplifier coupled to the up-conversion unit and to the antenna. Here, the transmit side subsystem is preferably configured to convert a digital signal to an analog signal, and then deliver the analog signal to the antenna.

In another embodiment of this system, the receive side subsystem may include an analog to digital converter coupled to the digital transmission path, a down-conversion unit coupled to the analog to digital converter, a low noise amplifier coupled to the down-conversion unit, and an HTS filter coupled to the low noise amplifier and the antenna. This receive side subsystem is preferably configured to receive an analog signal from the antenna, and then convert the analog signal to a digital signal. Furthermore, the receive side subsystem may include a cryocooler, a cryogenic enclosure in thermal communication with the cryocooler, and a cold stage within the cryogenic enclosure. The HTS filter and the low noise amplifier are preferably disposed on the cold stage. Additionally, the cryocooler may be a Stirling cryocooler.

This system of the present invention may also include receive electronics coupled to the digital transmission path, the receive electronics being configured to process digital signals. Likewise, the system may include transmit electronics coupled to the digital transmission path, the transmit electronics also being configured to generate digital signals.

Additionally, the system may include a plurality of multiplexers. For example, a first multiplexer may be provided that is coupled to the antenna, the transmit side subsystem and the receive side subsystem. Also, the system may include a second multiplexer that is coupled to the transmit side subsystem, the receive side subsystem, and the digital transmission path. Finally, this embodiment of the system may include a third multiplexer coupled to the digital transmission path, the receive electronics, and the transmit electronics. Preferably, the first multiplexer is configured to relay received signals from the antenna to the receive side subsystem and relay signals from the transmit side subsystem to the antenna. The second multiplexer is preferably configured to relay signals from the receive side subsystem to the digital transmission path and relay signals from the digital transmission path to the transmit side subsystem. The third multiplexer is preferably configured to relay signals from the digital transmission path to the receive electronics and relay signals from the transmit electronics to the digital transmission path. In one embodiment, the first, second, and third multiplexers are duplexers.

In another embodiment of this system of the present invention, a power distribution unit is provided. The power distribution unit may be coupled to the receive and transmit electronics. The power distribution unit is preferably operable to balance a strength of a digital signal generated by the transmit electronics with a strength of a digital signal received by the receive electronics. In one alternative, the power distribution unit is disposed atop the tower. In another alternative, the power distribution unit is located within the base station. Similarly, both the receive electronics and the transmit electronics may be disposed in the base station.

Other objects and features of the present invention will become apparent from consideration of the following description taken in conjunction with the accompanying drawings.

### DESCRIPTION OF THE DRAWINGS

FIG. 1 illustrates a first embodiment of a tower mounted transmitter/receiver system in accordance with the present invention.

FIG. 2 illustrates a second embodiment of a tower mounted transmitter/receiver system in accordance with the present invention, wherein the system includes a combined transmit/receive antenna.

FIG. 3a illustrates a third embodiment of a tower mounted transmitter/receiver system in accordance with the present invention, wherein the system includes a transmit side subsystem having a plurality of power amplifiers and a combiner.

FIG. 3b illustrates a fourth embodiment of a tower mounted transmitter/receiver system in accordance with the present invention, wherein the system includes a plurality of multiplexers and a transmit side subsystem having a plurality of power amplifiers.

FIG. 4 illustrates a fifth embodiment of a tower mounted transmitter/receiver system in accordance with the present invention, wherein the system is configured to generate and process digital signals.

FIG. 5 illustrates an embodiment of a system in accordance with the present invention that includes a plurality of remote transmitter/receiver systems coupled to a main base station.

FIG. 6 illustrates another embodiment of a system in accordance with the present invention that includes a plurality of remote transmitter/receiver systems coupled to a main base station.

### DETAILED DESCRIPTION

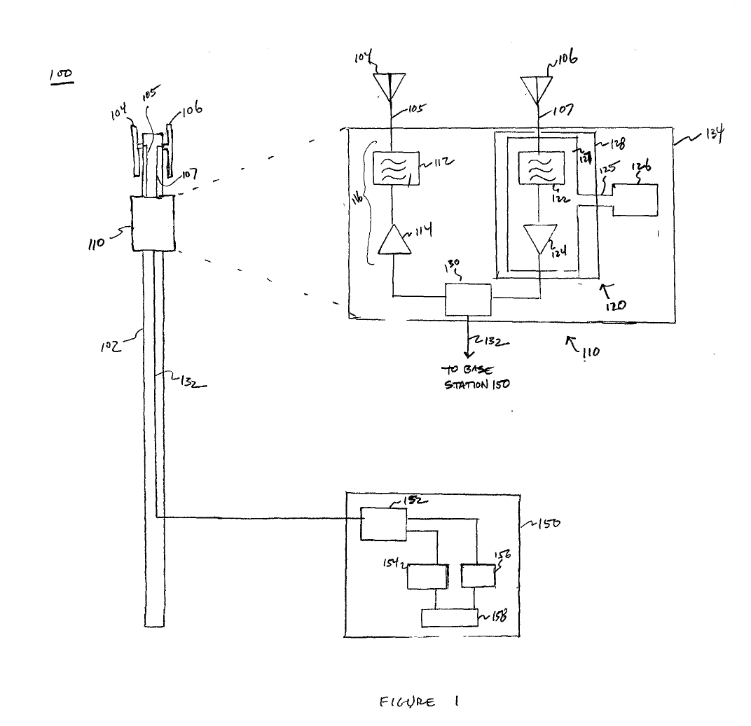

Turning now to the drawings, FIG. 1 illustrates a tower mounted telecommunications system 100 of the present invention. The system 100 includes a tower or mast 102 and a base station 150 located at the bottom of the tower 102. An antenna or a plurality of antennas is mounted towards the top of the tower 102. In the illustrated embodiment, a plurality of antennas, i.e., a transmit antenna 104 and a receive antenna 106, is mounted at the top of the tower 102. A transmit cable 105, which is preferably a coaxial cable, connects the transmit antenna 104 with a transmit side subsystem 116 located within a transmitter/receiver system 110. Similarly, a receive cable 107, which is also preferably a coaxial cable, connects the receive antenna 106 with a receive side subsystem 120 located within the transmitter/receiver system 110. The transmitter/receiver system 110 is mounted in close proximity to the antennas 104, 106 in order to minimize the cable length required to connect the antennas 104, 106 with the transmitter/receiver system 110. A transmission line 132, which is, like the transmit cable 105 and the receive cable 105, preferably a coaxial cable, connects the transmitter/receiver system 110 with the base station 150.

The transmitter/receiver system 110 preferably includes an environmentally protective system housing 134. The housing 134 contains the transmit side subsystem 116 and the receive side subsystem 120, and is designed to isolate the transmitter/receiver system 110 from ambient forces. Any suitable housing that insulates the transmitter/receiver system 110 from external forces and inclement weather may be used for the housing 134. The housing 134 may be mounted to the tower 102 using any suitable attachment means, such as, e.g., brackets, placement on a platform, being formed as an integral part of the tower 102, or the like.

As previously noted, the transmit side subsystem 116 is located within the housing 134. Preferably, the transmit side subsystem 116 includes a transmitter filter 112 and a power amplifier 114. In this embodiment of the system 100, the transmitter filter 112 is a conventional, non-superconducting filter. The transmit cable 105 connects the transmit antenna 104 with the transmitter filter 112. The transmitter filter 112, in turn, is coupled to the power amplifier 114.

The receive side subsystem 120 is also located within the housing 134. The receive side subsystem 120 is preferably an HTS-based RF front-end receiver that incorporates both an HTS filter 122 and a low noise amplifier 124 (LNA). Although one HTS filter 122 and one LNA 124 is shown in FIG. 1, a plurality of HTS filters 122 and a plurality of LNAs 124 may be incorporated into the receive side subsystem 120. The receive side subsystem 120 further includes a cryocooler 126 that is used to cool the HTS filter 122 and LNA 124, and possibly other electronic components that may be incorporated into the receive side subsystem 120.

The HTS filter 122 is preferably manufactured from a thin-film superconductor, although the present invention also contemplates other constructions such as thick-film superconductors. The thin-film superconductor may, for example, comprise a yttrium containing superconductor known generally as YBCO superconductors, or, alternatively, a thallium-based superconducting compound. U.S. Pat. No. 6,083,884, entitled, “A-axis high temperature superconducting films with preferential in-plane alignment,” and U.S. Pat. No. 5,358,926, entitled, “Epitaxial thin superconducting thallium-based copper oxide layers,” disclose exemplary thin-film superconductors that may be used with the present invention. The disclosures of the '884 and the '926 patents are fully and expressly incorporated by reference herein. The invention is not, however, limited to a particular type or class of superconductors, i.e., any HTS superconductor that will properly filter RF signals at HTS temperatures may be used in constructing the HTS filter 122.

The cryocooler 126 included within the receive side subsystem 120 may be any suitable cryocooler, such as, e.g., a Stirling cycle cryocooler, a Brayton cycle cryocooler, a Gifford-McMahon cryocooler, a pulse tube cryocooler, and the like. Exemplary cryocoolers are disclosed in U.S. Pat. No. 6,327,862, entitled, “Stirling cycle cryocooler with optimized cold end design,” and U.S. Pat. No. 6,141,971, entitled “Cryocooler motor with split return iron.” The disclosures of the '862 and the '971 patents are fully and expressly incorporated herein by reference. U.S. Pat. No. 6,311,498, entitled “Tower mountable cryocooler and HTSC filter system,” and which has already been incorporated by reference, also discusses cryocoolers suitable for use with the present invention.

The cryocooler 126 is thermally coupled at its cold end to a cryogenic enclosure 128 that contains the HTS components and other electronics. The cryogenic enclosure 128 is preferably a vacuum dewar. The use of a vacuum dewar for the cryogenic enclosure 128 minimizes the transfer of heat from the external environment to the inside of the cryogenic enclosure 128.

A cold stage 127 is preferably located within the cryogenic enclosure 128. The cold stage 127 preferably contains thereon the HTS filter 122 and the LNA 124. Optionally, other electronic components that are used in the receive side subsystem 120 may also be located upon the cold stage 127. The cold stage 127 may have a single face or a plurality of faces to hold a number of HTS filters 122 and LNAs 124. A cooling transfer segment 125 couples the cold stage 127 with the cryocooler 126. The cooling transfer segment 125 facilitates thermal transfer between the cold stage 127 and the cryocooler 126.

Further details of an exemplary receive side subsystem 120 suitable for use with the present invention are described in co-pending U.S. application Ser. No. 10/017,147, filed Dec. 13, 2001, and entitled, “MEMS-based bypass system for use with a HTS RF receiver,” which has been assigned to the assignee of the present invention. The specification of U.S. application Ser. No. 10/017,147 is fully and expressly incorporated by reference herein.

A RF signal is received by the receive antenna 106 and transmitted to the receive side subsystem 120 via the receive cable 107. Once received by the receive side subsystem 120, the RF signal, i.e., the received signal, is filtered by the HTS filter 122, and is amplified by the LNA 124. In the embodiment of the system 100 shown in FIG. 1, the filtered and amplified RF signal is then relayed to a first transmitter/receiver system duplexer 130.

Referring again to the transmit side subsystem 116, a RF signal is received by the power amplifier 114 from the first transmitter/receiver system duplexer 130. The power amplifier 114 increases the signal strength of the RF signal to a desired level, and then relays the amplified RF signal to the transmitter filter 112. The filtered, amplified RF signal is subsequently sent to the transmit antenna 104 via the transmit cable 105. The transmit antenna 104 then broadcasts the filtered, amplified RF signal, i.e., the transmitted signal, to the area covered by the system 100. In an alternative embodiment of system 100, the transmitter filter 112 is located within the base station 150 rather than atop the tower 102. In this alternative embodiment, a transmitted signal is filtered by the transmitter filter 112 prior to being amplified by the power amplifier 114.

As noted in the aforementioned discussion of the receive side subsystem 120 and the transmit side subsystem 116, the transmitter/receiver system 110 includes the first transmitter/receiver system duplexer 130. Use of the first transmitter/receiver system duplexer 130 enables the system 100 to carry both received and transmitted signals to and from the base station 150 using a single transmission line 132. Use of a single transmission line 132 to travel and extend between the tower 102 and the base station 150 reduces the space required to operate the system 100. The reduction of space through the use of a single transmission line 132 is of particular benefit in situations where an operator of the system 100 leases the space occupied by the system 100, i.e., less space needs to be leased in order to run the transmission line 132.

When transmitting a signal, transmit electronics 156 in the base station 150 generate the transmit signal, and relays the transmit signal to a base station side duplexer 152. As shown in FIG. 1, the base station side duplexer 152 may be disposed within the base station 150 itself. The base station side duplexer 152 combines the transmit signal into a combined signal that may include received signals, and the transmit signal is relayed via the transmission line 132 to the transmitter/receiver system 110.

In the transmitter/receiver system 100, the first transmitter/receiver system duplexer 130 splits the transmit signal from the combined signal that includes both received and transmitted signals, and then relays the transmitted signal to the power amplifier 114. When receiving a signal, the first transmitter/receiver system duplexer 130 combines a received signal with transmitted signals, and then relays the received signal, as a component of the combined signal, to the base station 150 via the transmission line 132. In the base station 150, the base station side duplexer 152 splits the received signal from the combined signal, and the received signal is provided to receive electronics 154 for processing.

As illustrated in FIG. 1, the system 100 further includes a power distribution unit 158 coupled to both the receive electronics 154 and the transmit electronics 156. The power distribution unit 158 is shown as being located within the base station 150. Alternatively, the power distribution unit 158 may be mounted atop the tower 102, in close proximity to the transmitter/receiver system 110. The power distribution unit 158 optimizes the operation of the system 100 by determining the coverage range or radius of the receive side subsystem 120, and then setting the power of the power amplifier 114 of the transmit side subsystem 116 to substantially match the coverage range or radius of the receive side subsystem 120. In doing so, the power distribution unit 158 ensures that users within an area covered by the system 100 can both transmit and receive RF signals. In another embodiment of the power distribution unit 158, the power distribution unit 158 merely provides a source of power to the transmit electronics 156, and optionally also the receive electronics 154.

For either embodiment, a computer (not shown), such as, e.g., a personal computer, a notebook computer, a personal digital assistant, and the like, may be coupled to the power distribution unit 158 in order to diagnose any problems that may arise during the operation of the system 100. Here, the computer is configured to download data regarding the power usage of the transmit electronics 156 and/or the receive electronics 154 from the power distribution unit 158. Using the power usage data, the computer is able to determine any abnormal operation characteristics of either the transmit electronics 156 and/or the receive electronics 154, thereby enabling the diagnosis and resolution of any problems by the operators of the system 100.

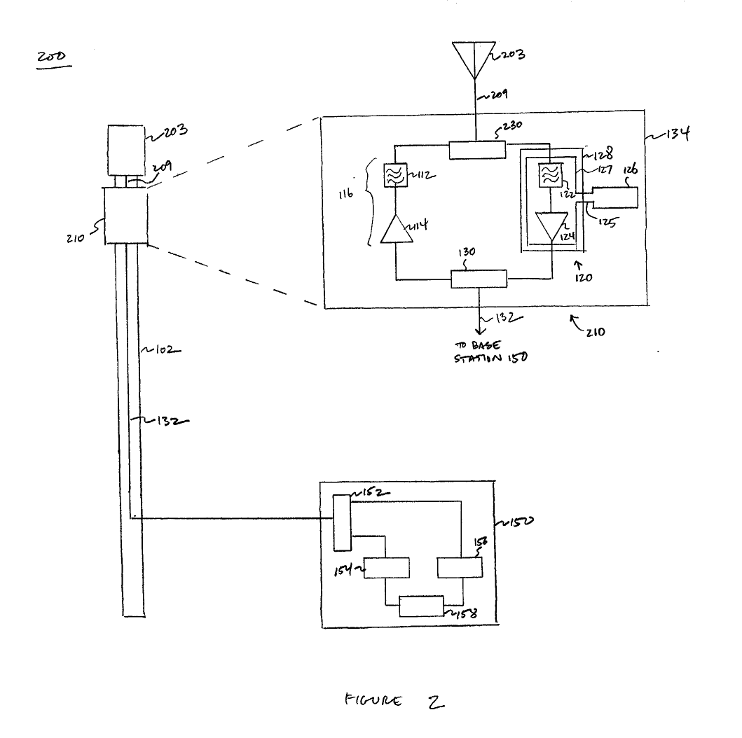

Turning now to FIG. 2, another system of the present invention, tower mounted system 200, is illustrated. System 200 includes many of the same components as system 100. For the sake of simplicity, the numbering of the common components of systems 100 and 200 will remain constant. Further, reference is made to the description of these common components in the earlier discussion of system 100. For example, system 200 includes a tower 102 and a base station 150, with the base station 150 containing at least receive electronics 154, transmit electronics 156, and, optionally, a power distribution unit 158. The power distribution unit 158 may alternatively be located atop the tower 102 in close proximity to a transmitter/receiver system 210. A base station side duplexer 152 may also be placed within the base station 150. A transmission line 132 extends between the base station side duplexer 152 and the transmitter/receiver system 210, and the base station side duplexer 152 is further coupled to the receive and transmit electronics 154, 156. Also, as with system 100, the base station side duplexer 152 may combine and split transmitted and received signals that are carried via the transmission line 132 between the transmitter/receiver system 210 and the receive and transmit electronics 154, 156 within the base station 150.

System 200 incorporates a combined transmit/receive antenna 203. The transmit/receive antenna 203 may be any antenna capable of both transmitting signals and receiving signals in a single unit. The transmit/receive antenna 203 is coupled to the transmitter/receiver system 210 via a single transmit/receive cable 209. Through the use of a single transmit/receive cable 209 between the antenna 203 and the transmitter/receiver system 210, as well as a single transmission line 132 between the transmitter/receiver system 210 and the base station 150, system 200 further reduces the space required for operation. This provides a benefit in cost savings if, for example, space must be leased for the cable runs.

The transmitter/receiver system 210 contains a transmit side subsystem 116 and a receive side subsystem 120 that are substantially similar to the subsystems in system 100, and reference is made to the description of these subsystems with regard to system 100 for further operational details.

In addition to the components contained in the transmitter/receiver system 110 of system 100, such as, e.g., the first transmitter/receiver system duplexer 130, the transmitter/receiver system 210 of system 200 further incorporates a second transmitter/receiver system duplexer 230. The second transmitter/receiver system duplexer 230 splits a received signal from the transmit/receive antenna 203 from a transmitted signal from the transmit side subsystem 116, both of the transmitted and received signals being carried on the transmit/receive cable 209 as part of a combined signal, and relays the received signal to the receive signal subsystem 120 for processing. Also, the second transmitter/receiver system duplexer 230 combines the transmitted signals with the received signals in order to relay the transmitted signals to the transmit/receive antenna 203 via the transmit/receive cable 209, as a component of a combined signal.

As noted, the first transmitter/receiver system duplexer 130 is provided within the transmitter/receiver system 210 to combine received signals with transmitted signals in order to send the received signals, as part of a combined signal, to the base station 150. Within the base station 150, the base station side duplexer 152 splits the received signals from the combined signal, and then relays the received signals to the receive electronics 154. The base station side duplexer 152 also receives transmitted signals from the transmit electronics 156, combines the transmitted signals with received signals in order to send the transmitted signals, as part of a combined transmit/receive signal, to the transmitter/receiver system 210 via the transmission line 132. Within the transmitter/receiver system 210, the first transmitter/receiver system duplexer 130 splits the transmitted signals from the combined transmit/receive signal, and relays the transmitted signals to the transmit side subsystem 116 for further processing.

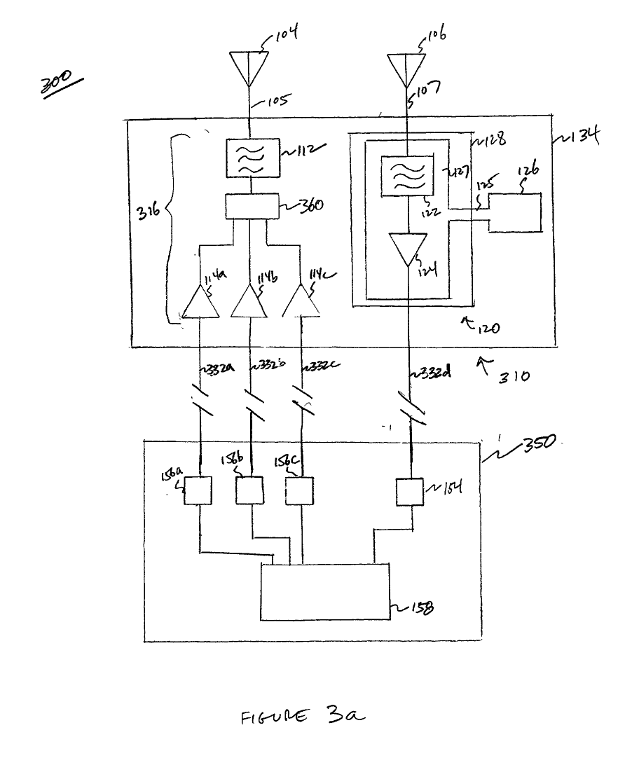

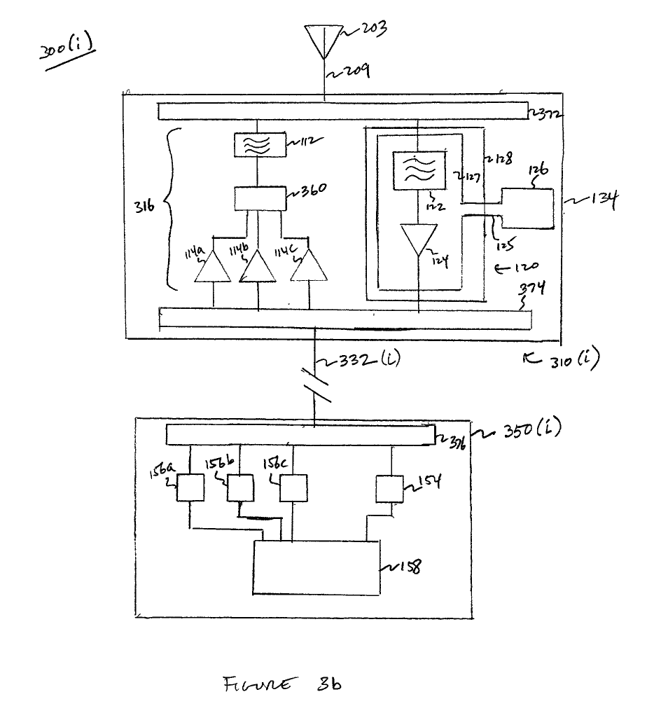

FIG. 3a illustrates another embodiment of a system of the present invention, namely, tower mounted system 300. System 300, as with the other embodiments of the systems of the present invention, includes a transmitter/receiver system 310 and a base station 350. Although not shown in FIG. 3a, it should be appreciated that the transmitter/receiver system 310 is mounted atop a tower (not shown). System 300 includes components that are also used with the other systems of the present invention. Accordingly, for these common components, identical numbering is used for system 300. Additionally, reference is made to the descriptions of the other systems, such as, e.g., system 100, for the details of these common components.

The transmitter/receiver system 310 of system 300 includes a transmit side subsystem 316 that incorporates a plurality of powered amplifiers 114a, 114b, 114c, rather than a single powered amplifier, such as, e.g., in system 100. Although three powered amplifiers 114a-c are illustrated in FIG. 3a, a smaller or a greater number of powered amplifiers may be used. Each powered amplifier 114a-c receives a transmitted signal from a transmit electronics unit 156a-c located within base station 350. Each powered amplifier 114a-c is coupled to a transmit electronics unit 156a-c via a transmission line 332a-c, respectively. Preferably, a like number of transmit electronics units and powered amplifiers is used, i.e., in embodiments of-system 300 incorporating more than three powered amplifiers, an equivalent number of transmit electronics units is provided in the base station 350. Alternatively, differing numbers of powered amplifiers and transmit electronics units may be used by incorporating multiplexers to combine signals in order to compensate for odd numbers of powered amplifiers and transmit electronics units. Turning back to the embodiment shown in FIG. 3a, each transmit electronics unit 156a-c is further coupled to a power distribution unit 158, and the power distribution unit 158 is also coupled to receive electronics 154. Although illustrated as being within base station 350, the power distribution unit 158 may alternatively be mounted atop the tower (not shown). The power distribution unit 158 is operable to balance the signal strengths of the transmitted signals with the signal strengths of received signals received by the receive antenna 106, and processed by the receive side subsystem 120 and receive electronics 154. Here, the receive side subsystem 120 and receive electronics 154 are coupled via a reception line 332d.

The transmit side subsystem 316 further includes a signal combiner 360 coupled to the powered amplifiers 114ac, as well as a transmitter filter 112. The signal combiner 360 combines the amplified, transmitted signals sent by the powered amplifiers 114a-c into a single combined transmitted signal, and then relays the combined transmitted signal to the transmitter filter 112. The combined transmitted signal is subsequently sent to the transmit antenna 104 for broadcast to the area covered by the system 300.

An alternative embodiment of system 300, system 300(i), is illustrated in FIG. 3b. System 300(i) incorporates a single combined transmit/receive antenna 203, which has been discussed with respect to system 200, in lieu of the separate transmit antenna 104 and receive antenna 106 of system 300.

Multiplexers 372, 374, and 376 are also included in system 300(i). A first multiplexer 374 is provided within the transmitter/receiver system 310(i). The first multiplexer 374 provides transmitted signals to the power amplifiers 114a-c, and also receives a received signal from the receive side subsystem 120 and relays the received signal to the base station 350(i) via transmission line 332(i). only a single transmission line 332(i) is required to transmit signals between the transmitter/receiver system 310(i) and the base station 350(i) since the multiplexers 372, 374, and 376 are configured to process combined transmit/receive signals, similar to the duplexers discussed with respect to other embodiments of the present invention.

The transmitted signals provided to the power amplifiers 114a-c by the first multiplexer 374 are processed in a substantially similar manner as the processing of transmitted signals in system 300. With system 300(i), however, the filtered, combined transmitted signal is processed by a second multiplexer 372, i.e., combined with received signals to form a combined transmit/receive signal, prior to being sent to the combined antenna 203 via the transmit/receive cable 209. The transmitted signal is then broadcast to the coverage area by the combined antenna 203.

The combined antenna 203 receives RF signals from the coverage area, and relays the received signals, as a component of a combined transmit/receive signal, to the second multiplexer 372. The second multiplexer 372 provides the received signals to the receive side subsystem 120 for processing. The received signals are then provided to the first multiplexer 374, which transmits the received signals to a base station side multiplexer 376 via a transmission line 332(i) as part of a combined transmit/receive signal. The base station side multiplexer 376 is operable for splitting received signals from a combined transmit/receive signal, and providing received signals to receive electronics 154. The base station side multiplexer 376 is also capable of receiving transmitted signals from transmit electronics 156a-c, combining those signals with received signals, and relaying the transmitted signals, as part of the combined signal, to the first multiplexer 374. As illustrated, the base station side multiplexer 376 is disposed within base station 350(i).

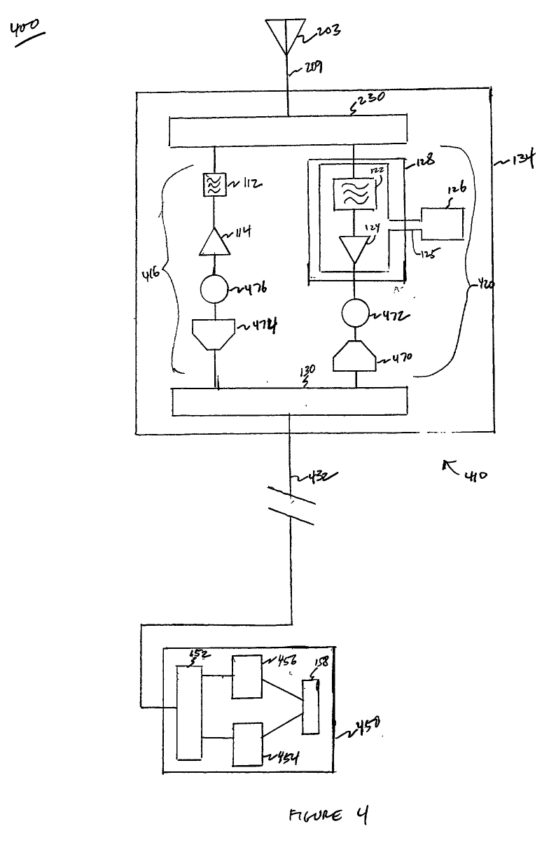

Turning now to FIG. 4, another embodiment of the present invention, tower mounted system 400, is illustrated. System 400 includes many of the same components that are also included in other embodiments of the systems of the present invention, such as, e.g., system 200 that is illustrated in FIG. 2. Therefore, common components of systems 200 and 400 are identified by the same numbers. Additionally, reference is made to the description of these components with regard to system 200, as these components operate substantially the same in system 400.

System 400 incorporates a digital fiber transmission line 432, which may be, e.g., a fiber optic cable, that enables the system 400 to transmit and receive digital signals. Digital transmission signals are sent to a transmitter/receiver system 410 from a base station 150 via the digital fiber transmission line 432. In a similar fashion, digital received signals are sent to a base station 450 from the transmitter/receiver system 410 via the digital fiber transmission line 432. As with the other embodiments of the present invention, the transmitter/receiver system 410 is preferably mounted atop a tower (not shown). Because a single digital transmission line 432 is used to carry digital signals between the transmitter/receiver system 410 and the base station 450, a base station side duplexer 152 is provided in the base station 150 to split the transmitted and received signals from a combined signal. Also, a first transmitter/receiver duplexer 130 is provided in the transmitter/receiver system 410 to combine the received signals with the transmitted signals into a combined signal prior to the transmitter/receiver system 410 sending the received signal, which is within the combined signal, to the base station 450 via the digital transmission line 432. In a similar fashion, the first transmitter/receiver duplexer 130 splits a transmitted signal from the combined signal prior to relaying the transmitted signal to the transmit side subsystem 416.

Turning to the transmit side subsystem 416, the subsystem 416 includes a digital to analog converter (DAC) 474 that receives a digital transmitted signal from the first transmitter/receiver system duplexer 130. The DAC 474 converts the digital transmitted signal to an analog signal. An up-conversion unit 476 then processes the analog transmitted signal to suppress any distortion introduced by the DAC 474. The up-conversion unit 476 includes at least one mixer and one filter, and may include a plurality of mixers and filters. To process a signal, the up-conversion unit 476 receives an analog transmitted signal that is at a base frequency. A mixer of the up-conversion unit 476 is utilized to increase the frequency of the analog transmitted signal to an intermediate frequency. A filter of the up-conversion unit 476 is then utilized to eliminate any extraneous noise and distortion introduced by increasing the analog transmitted signal to the intermediate frequency. The up-conversion unit 476 may be operated to increase the frequency of the analog transmitted signal to a plurality of intermediate frequencies. Finally, a mixer of the up-. conversion unit 476 is used to increase the analog transmitted signal from an intermediate frequency to an operating frequency, and a filter of the up-conversion unit 476 is used to eliminate extraneous noise and distortion that may be introduced by increasing the analog transmitted signal to the operating frequency.

The processed analog transmitted signal is then amplified by the power amplifier 114, which relays the amplified signal to a RF filter 112. The transmitted signal is combined by a second transmitter/receiver system duplexer 230 into a combined signal with received signals, and the transmitted signal, as part of a combined signal, is relayed to a transmit/receive antenna 203, via a transmission line 209, for broadcast into the area covered by the system 400.

The transmit/receive antenna 203 receives signals from the coverage area and relays the received signals to the second transmitter/receiver system duplexer 230 as part of a combined signal that includes transmit signals. Here, the transmit/receive antenna 203 receives analog signals. The second transmitter/receiver system duplexer 230 separates the received signals from the combined signal, and sends the received signals to a cryogenically cooled receive side subsystem 420, which includes similar cryogenically cooled components as the other receive side subsystems of the present invention, such as, e.g., receive side subsystem 120. Regarding the processing of the received signals by the cryogenically cooled portions of the receive side subsystem 420, reference is made to the discussion of the receive side subsystem 120 elsewhere in this specification. The receive side subsystem 420 further includes a down-conversion unit 472 to condition the analog received signals prior to processing by an analog-to-digital converter (ADC) 470. Similar to the up-conversion unit 476, the down-conversion unit 472 includes at least one mixer and one filter, and may include a plurality of mixers and filters. To process a signal, the down-conversion unit 472 receives an analog received signal that is at an operating frequency. A mixer of the down-conversion unit 472 is utilized to decrease the frequency of the analog received signal to an intermediate frequency. A filter of the down-conversion unit 472 is then utilized to eliminate any extraneous noise and distortion introduced by decreasing the analog received signal to the intermediate frequency. Like the up-conversion unit 476, the down-conversion unit 472 may be operated to decrease the frequency of the analog received signal to a plurality of intermediate frequencies. Finally, a mixer of the down-conversion unit 472 is used to decrease the analog received signal from an intermediate frequency to a base frequency. A filter of the down-conversion unit 472 is then used to eliminate extraneous noise and distortion that may be introduced by decreasing the analog received signal to the operating frequency.

The ADC 470 converts the processed analog received signals to digital received signals, and then the first transmitter/receiver system duplexer 130 combines the received signals with transmitted signals, and the combined signal is sent to the base station 450 for further processing via the digital fiber transmission line 432. Receive electronics 454 and transmit electronics 456 that are capable of processing digital signals are provided within the base station 450. Additionally, a power distribution unit 158 may also provided within the base station 450 in order to equalize the signal strengths of the transmitted signals relative to the received signals. Alternatively, the power distribution unit 158 may be mounted atop the tower (not shown).

In an alternative embodiment of system 400, separate transmit and receive antennas (not shown) are used rather than a single transmit/receive antenna 203. In this alternative embodiment, the second transmitter/receiver system duplexer 230 is not provided since there is no need to combine signals prior to sending a transmit signal to the transmit antenna, nor is there a need to split a receive signal, from a combined signal, received from the receive antenna prior to further processing by the receive side subsystem 420.

In a further alternative embodiment of the system 400, the antenna of the system, which may be the combined antenna 203 or discrete transmit and receive antennas, is configured to digitally transmit and receive signals. With this embodiment, the need to convert digital signals to analog, and vice versa, is eliminated. Consequently, this alternative embodiment of system 400 does not include the DAC 474 and up-conversion unit 476 within the transmit side subsystem 416. Furthermore, this system does not include the ADC 470 and the down-conversion unit 472 in the receive side subsystem 420. These components are unnecessary in this alternative embodiment of system 400 because this system does not transmit or receive analog signals, but, rather, transmits and receives digital signals exclusively.

For any of the systems of the present invention, a switched bypass unit (not shown) may be incorporated into the transmitter/receiver systems. In the event of an electrical surge in a receive path of the systems, a switched bypass unit located within the receive side subsystems directs the receive signals around the HTS filters. Also included in the switched bypass unit may be one or more LNAs, which may or may not be cooled, along with any other circuitry in the path of the receive signals that may be considered prone to failure. A switched bypass unit may also be provided in the transmit side subsystem to allow the subsystem to operate notwithstanding a catastrophic failure of any of the components of a transmit side subsystem of a system of the present invention. A suitable switched bypass unit is disclosed in co-pending U.S. application Ser. No. 10/017,147, entitled, “MEMS-based bypass system for use with a HTS RF receiver,” which has already been fully and expressly incorporated by reference herein.

Other alternative embodiments of the systems of the present invention disclosed herein may incorporate more than two antennas. In these alternative embodiments, suitable multiplexers are incorporated into the systems. For example, in embodiments of the system that include three antennas, triplexers are incorporated within the transmitter/receiver systems and the base stations. Similarly, in embodiments of the system that include four antennas, quadplexers are included in the transmitter/receiver systems and in the base stations. Accordingly, in embodiments of the system with more than two antennas, multiplexers that are suitable for processing the number of signal paths generated by the number of antennas are included.

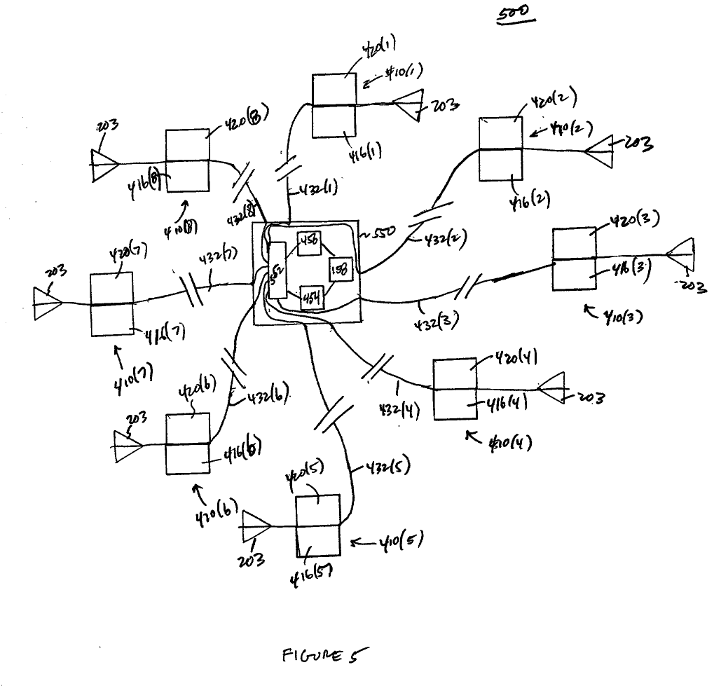

Turning now to FIG. 5, FIG. 5 illustrates a system 500 according to the present invention that includes a plurality of transmitter/receiver systems 410(1 to n) installed at a plurality of locations in a coverage area. Like system 400 shown in FIG. 4, system 500 is configured to transmit and receive digital signals. The illustrated embodiment of system 500 includes eight transmitter/receiver systems 410, which are identified as 410(1) to 410(8). It will be appreciated, however, that either a greater number or smaller number of transmitter/receiver systems 410 may be included with system 500.

The plurality of transmitter/receiver systems 410(1 to 8) are coupled to a main base station 550. Each transmitter/receiver system 410(1 to 8) is also preferably coupled to a corresponding combined transmit/receive antenna 203(1 to 8).

System 500 is not limited to tower mounted installations. Rather, each transmitter/receiver system 410(1 to 8) is mountable at various locations within the coverage area, and at locations within the coverage area that are remote from the main base station 550. Moreover, each transmitter/receiver system 410(1 to 8) is preferably located in proximity to the users of the system. Exemplary locations for placement of a transmitter/receiver system 410(1 to 8) include, e.g., at various locations within a building, within the interior space of the walls of a building, on street lamps, on billboards, on street signs, and the like. Each transmitter/receiver system 410(1 to 8) is coupled to the main base station 550 via a digital fiber transmission line 432(1 to 8).

Within the main base station 550, receive electronics 454 and transmit electronics 456 are provided. A power distribution unit 158 is also provided within the main base station 550, and is coupled to both the receive electronics 454 and the transmit electronics 456. Further, a multiplexer 552 is provided within the main base station 550. Multiplexer 552 is coupled to each digital fiber transmission line 432(1 to 8) that is coupled to the transmitter/receiver systems 410(1 to 8). Multiplexer 552 is further coupled to both the receive electronics 454 and the transmit electronics 456. Consequently, multiplexer 552 is configured to relay signals between the transmitter/receiver systems 410(1 to 8) and the receive and transmit electronics 454, 456. Multiplexer 552 processes and relays transmit and receive signals in a manner substantially similar to base station side duplexer 152, and reference is made to the description of base station side duplexer 152.

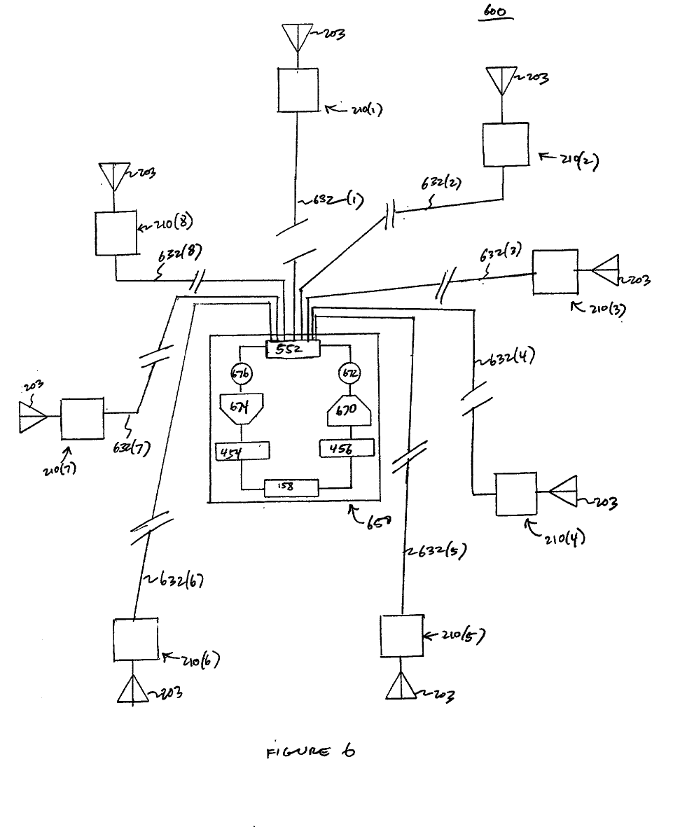

An alternative embodiment of system 500, system 600, is illustrated in FIG. 6. With system 600, digitizing of analog receive signals, and conversion of digital transmit signals to analog, is accomplished within main base station 650, rather than in the transmitter/receiver systems 210(1 to n). System 600 includes a plurality of transmitter/receiver systems 210(1 to 8). Transmitter/receiver systems 210 have been previously described in the discussion of system 200, and reference is made to that description. For example, although not shown in FIG. 6, each transmitter/receiver system 210(1 to 8) includes a receive side subsystem 120 having an HTS filter 122, a transmit side subsystem 116, and first and second transmitter/receiver system duplexers 130, 230. Also, in a similar manner as with system 500, a greater or smaller number of transmitter/receiver systems 210 may be included in system 600.

Because the conversion of signals between analog and digital form is performed within main base station 650, the transmitter/receiver systems 210(1 to 8) do not include DAC, ADC, up-converter units, or down-converter units. Rather, to convert digital transmit signals to analog transmit signals, the main base station 650 includes a DAC 674 coupled to the transmit electronics 454, and an up-conversion unit 676 coupled to the DAC 674 and the multiplexer 552. Reference is made to the description of DAC 474 and up-conversion unit 476 of system 400 for details on the operation of DAC 674 and up-conversion unit 676.

Additionally, to convert analog receive signals to digital receive signals, the main base station 650 includes an ADC 670 coupled to the receive electronics 456, and a down-conversion unit 672 coupled to the ADC 670 and the multiplexer 552. Reference is made to ADC 470 and down-conversion unit 472 for a description of the ADC 670 and down-conversion unit 672.

To transmit analog signals between a transmitter/receiver system 210(1 to 8) and the base station 650, a linkage 632(1 to 8) is provided. In one embodiment each linkage 632(1 to 8) is a digital fiber or optical fiber, similar to transmission line 432(1 to 8) of system 500. In another embodiment, each linkage 632(1 to 8) is a remote antenna unit operable to wirelessly transmit analog signals between the transmitter/receiver systems 210(1 to 8) and the base station.

Systems 500, 600 are particularly useful for use in telecommunications systems that incorporate standards such as 3G. For example, systems 500, 600 provide for a plurality of “underlay” units, which are the transmitter/receiver systems 410(1 to n), 210(1 to n), for a 3G system, and places the underlay units closer to the users of the system. Because the antennas 203 coupled to the transmitter/receiver systems 410(1 to n), 210(1 to n) are located closer to the users, the attenuation of the signals processed by the systems 500, 600 decreases. The probability of interfering signals from competitive systems increases, however, because the transmitter/receiver systems 410(1 to n), 210(1 to n) may also be located closer to the users of those systems. The use of superconducting materials within the transmitter/receiver systems 410(1 to n), 210(1 to n), and particularly within the receive side subsystems 420, 120, operates to minimize and eliminate these interfering signals. For example, in telecommunications systems implementing 3G standards, competitors' signals are close in frequency, and the use of superconducting materials within the transmitter/receiver systems 410(1 to n), 210(1 to n) allows systems 500, 600 to filter out competitors' signals with greater efficiency and effect than systems that do not incorporate superconducting materials.

While the invention is susceptible to various modifications and alternative forms, specific examples thereof have been shown in the figures and are described herein in detail. It should be understood, however, that the invention is not to be limited to the particular forms, systems, or methods disclosed. Furthermore, other aspects and embodiments of the invention will be apparent to those skilled in the art from consideration of the specification and practice of the invention disclosed herein. The invention is intended to cover all modifications, equivalents, and alternatives falling within the spirit and scope of the appended claims.

What is claimed is:

1. A tower mounted transmitter/receiver system, comprising:
a transmit antenna disposed on a tower;
a receive antenna disposed on the tower;
a transmit side subsystem disposed atop the tower and in communication with the transmit antenna, the transmit side subsystem including a powered amplifier;
a receive side subsystem disposed atop the tower and in communication with the receive antenna, the receive side subsystem including an HTS filter; and
a transmission path between a base station located at a base of the tower and the transmit and receive side subsystems.

2. The system of claim 1, wherein the transmit antenna and the receive antenna are incorporated into a combined transmit/receive antenna, the system further comprising:
a first duplexer coupled to the combined antenna, the transmit side subsystem, and the receive side subsystem, the first duplexer configured to provide a transmit signal to the combined antenna from the transmit side subsystem, and provide a receive signal to the receive side subsystem from the combined antenna.

3. The system of claim 2, further comprising:
a second duplexer coupled to the transmit side subsystem, the receive side subsystem, and the transmission path, the second duplexer configured to provide a transmit signal to the transmit side subsystem, and send a receive signal to the base station via the transmission path.

4. The system of claim 3, further comprising:
receive electronics disposed within the base station;
transmit electronics disposed within the base station; and
a third duplexer coupled to the transmission path, the receive electronics and the transmit electronics, the third duplexer configured to provide a receive signal to the receive electronics relayed from the second duplexer via the transmission path, and send a transmit signal from the transmit electronics to the second duplexer via the transmission path.

5. The system of claim 4, further comprising:
a power distribution unit coupled to the receive electronics and the transmit electronics, the power distribution unit configured to balance a strength of a transmit signal generated by the transmit electronics with a strength of a receive signal received by the receive electronics.

6. The system of claim 1, further comprising:
receive electronics coupled to the transmission path;
transmit electronics coupled to the transmission path;
a first duplexer coupled to the transmit side subsystem, the receive side subsystem, and the transmission path; and
a second duplexer coupled to the receive electronics, the transmit electronics, and the transmission path;
wherein the first duplexer is configured to provide transmitted signals to the transmit side subsystem and receive received signals from the receive side subsystem, and the second duplexer is configured to receive transmitted signals from the transmit electronics and relay received signals to the receive electronics.

7. The system of claim 1, wherein the transmit side subsystem further comprises a RF filter in communication with the power amplifier and the transmit antenna.

8. The system of claim 1, wherein the receive side subsystem further comprises:
a cryocooler;
a cryogenic enclosure in thermal communication with the cryocooler; and
a low noise amplifier coupled to the HTS filter;
wherein the HTS filter and the low noise amplifier are disposed within the cryogenic enclosure.

9. The system of claim 1, further comprising:
receive electronics coupled to the transmission path;
transmit electronics coupled to the transmission path; and
a power distribution unit coupled to the receive electronics and the transmit electronics;
wherein the power distribution unit balances a strength of a transmit signal generated by the transmit electronics with a strength of a receive signal received by the receive electronics.

10. The system of claim 9, wherein the receive electronics, the transmit electronics, and the power distribution unit are disposed within the base station.

11. The system of claim 1, wherein the transmit side subsystem comprises:
a signal combiner;
a plurality of power amplifiers coupled to the signal combiner; and
a RF transmitter filter coupled to the signal combiner;
wherein the signal combiner receives a plurality of transmitted signals from the plurality of power amplifiers, combines the plurality of transmitted signals into a single transmitted signal, and relays the transmitted signal to the RF transmitter filter.

12. A tower mounted transmitter/receiver system, comprising:
an antenna disposed on a tower, the antenna configured to receive and transmit RF signals;
a transmit side subsystem disposed atop the tower and in communication with the antenna, the transmit side subsystem including a powered amplifier;
a receive side subsystem disposed atop the tower and in communication with the antenna, the receive side subsystem including an HTS filter;
receive electronics in communication with the receive side subsystem; and
transmit electronics in communication with the transmit side subsystem.

13. The system of claim 12, wherein the receive side subsystem further comprises:
a cryocooler;
a cryogenic enclosure in thermal communication with the cryocooler;
a cold stage within the cryogenic enclosure; and
a low noise amplifier coupled to the HTS filter; wherein the HTS filter and the low noise amplifier are located within the cryogenic enclosure and disposed upon the cold stage.

14. The system of claim 12, wherein the transmit side subsystem further comprises:
a RF transmitter filter coupled to the power amplifier, wherein the RF transmitter filter relays transmitted signals from the power amplifier to the antenna.

15. The system of claim 12, further comprising:
a first duplexer coupled to the receive electronics and the transmit electronics;
a second duplexer coupled to the transmit side subsystem, the receive side subsystem, and the first duplexer; and
a third duplexer coupled to the antenna, the transmit side subsystem, and the receive side subsystem;
wherein the first duplexer is configured to relay received signals from the second duplexer to the receive electronics and relay transmitted signals from the transmit electronics to the second duplexer, the second duplexer is configured to relay transmitted signals from the first duplexer to the transmit side subsystem and relay received signals from the receive side subsystem to the first duplexer, and the third duplexer is configured to receive transmitted signals from the transmit side subsystem, relay the transmitted signals to the antenna, receive received signals from the antenna, and relay the received signals to the receive side subsystem.

16. The system of claim 15, wherein the first duplexer, the receive electronics, and the transmit electronics are disposed within a base station.

17. A tower mounted transmitter/receiver system, comprising:
an antenna disposed on a tower, the antenna configured to receive and transmit RF signals;
a transmit side subsystem disposed atop the tower and in communication with the antenna, the transmit side subsystem configured to process digital signals;
a receive side subsystem disposed atop the tower and in communication with the antenna, the receive side subsystem configured to process digital signals; and
a digital transmission path between a base station located at a base of the tower and the transmit and receive side subsystems.

18. The system of claim 17, wherein the antenna further comprises:
a transmit antenna in communication with the transmit side subsystem; and
a receive antenna in communication with the receive side subsystem.

19. The system of claim 17, wherein the digital transmission path comprises a fiber optic cable.

20. The system of claim 17, wherein the transmit side subsystem comprises:
a digital to analog converter coupled to the digital transmission path;
an up-conversion unit coupled to the digital to analog converter; and
a power amplifier coupled to the up-conversion unit and to the antenna;
wherein the transmit side subsystem is configured to convert a digital signal to an analog signal, and deliver the analog signal to the antenna.

21. The system of claim 17, wherein the receive side subsystem comprises:
an analog to digital converter coupled to the digital transmission path;
a down-conversion unit coupled to the analog to digital converter;
a low noise amplifier coupled to the down-conversion unit; and
an HTS filter coupled to the low noise amplifier and the antenna;
wherein the receive side subsystem is configured to receive an analog signal from the antenna and convert the analog signal to a digital signal.

22. The system of claim 21, wherein the receive side subsystem further comprises:
a cryocooler;
a cryogenic enclosure in thermal communication with the cryocooler; and
a cold stage within the cryogenic enclosure;
wherein the HTS filter and the low noise amplifier are disposed on the cold stage.

23. The system of claim 22, wherein the cryocooler is a Stirling cryocooler.

24. The system of claim 17, further comprising:
receive electronics coupled to the digital transmission path, the receive electronics configured to process digital signals; and
transmit electronics coupled to the digital transmission path, the transmit electronics configured to generate digital signals.

25. The system of claim 24, further comprising:
a first multiplexer coupled to the antenna, the transmit side subsystem and the receive side subsystem;
a second multiplexer coupled to the transmit side subsystem, the receive side subsystem, and the digital transmission path; and
a third multiplexer coupled to the digital transmission path, the receive electronics, and the transmit electronics;
wherein the first multiplexer is configured to relay received signals from the antenna to the receive side subsystem and relay signals from the transmit side subsystem to the antenna, the second multiplexer is configured to relay signals from the receive side subsystem to the digital transmission path and relay signals from the digital transmission path to the transmit side subsystem, and the third multiplexer is configured to relay signals from the digital transmission path to the receive electronics and relay signals from the transmit electronics to the digital transmission path.

26. The system of claim 25, wherein the first, second, and third multiplexers are duplexers.

27. The system of claim 24, further comprising:
a power distribution unit coupled to the receive and transmit electronics, wherein the power distribution unit balances a strength of a digital signal generated by the transmit electronics with a strength of a digital signal received by the receive electronics.

28. The system of claim 27, wherein the power distribution unit is disposed atop the tower.

29. The system of claim 27, wherein the power distribution unit is disposed in the base station.

30. The system of claim 24, wherein the receive and transmit electronics are disposed in the base station.
